(19) United States
(12) Patent Application Publication
(10) Pub. No.: US 2026/0153140 A1
(43) Pub. Date: Jun. 4, 2026

(54) POWER TRANSMISSION DEVICE AND POWER TRANSMISSION UNIT

(71) Applicant: SUMITOMO HEAVY INDUSTRIES, LTD., Tokyo (JP)

(72) Inventors: Masato IWATA, Yokosuka-shi (JP); Tomohiro KANEISHI, Yokosuka-shi (JP); Koji MORITANI, Yokosuka-shi (JP); Yuta MATSUMOTO, Yokosuka-shi (JP)

(21) Appl. No.: 19/384,929

(22) Filed: Nov. 10, 2025

(30) Foreign Application Priority Data
Dec. 2, 2024 (JP) 2024-209608

(51) Int. Cl. F16H 57/02

(52) U.S. Cl. CPC F16H 57/02; F16H 2057/02021

(57) ABSTRACT

There is provided a power transmission device including: a main body portion connected to a mating member disposed outside the power transmission device; and a device-side alignment mark portion provided in the main body portion to specify a misalignment between the main body portion and the mating member in cooperation with a mating-side alignment mark portion provided in the mating member.

### CROSS-REFERENCE TO RELATED APPLICATIONS

This application claims priority to Japanese Patent Application No. 2024-209608, filed on Dec. 2, 2024, which is incorporated by reference herein in its entirety.

### BACKGROUND

### Technical Field

Certain embodiments of the present disclosure relate to a power transmission device and a power transmission unit.

### Description of Related Art

The related art discloses a power transmission device including a main body portion connected to a mating member.

### SUMMARY

According to an embodiment of the present disclosure, there is provided a power transmission device. The power transmission device includes a main body portion connected to a mating member disposed outside the power transmission device, and a device-side alignment mark portion provided in the main body portion to specify a misalignment between the main body portion and the mating member in cooperation with a mating-side alignment mark portion provided in the mating member.

According to another embodiment of the present disclosure, there is provided a power transmission unit. The power transmission unit includes the power transmission device in the above-described aspect, and a mating member connected to the main body portion and provided with the mating-side alignment mark portion.

### BRIEF DESCRIPTION OF THE DRAWINGS

FIG. 1 is a perspective view showing a power transmission device according to an embodiment.

FIG. 2 is a perspective view showing a power transmission unit according to an embodiment.

FIG. 3 is a partial sectional side view showing a part of the power transmission unit in FIG. 2.

FIG. 4A is a side sectional view showing a periphery of a part A in FIG. 2, and FIG. 4B is a sectional view taken along line B-B in FIG. 4A.

FIG. 5 is a perspective view when a periphery of a part B in FIG. 2 is viewed from another viewpoint.

FIG. 6 is a view when the periphery of the part B in FIG. 2 is viewed from an inside in a radial direction.

FIG. 7 is a view showing a state where a first mating-side alignment mark portion and a first device-side alignment mark portion are misaligned from a reference position.

FIG. 8 is a view showing a state where a second mating-side alignment mark portion and a second device-side alignment mark portion are misaligned from a reference position.

### DETAILED DESCRIPTION

When a strong impact load or the like is applied to the main body portion of the power transmission device or to the mating member, the main body portion and the mating member may be misaligned. There is no proposed power transmission device that takes measures to easily specify the misalignment when the misalignment occurs between the main body portion and the mating member.

It is desirable to provide a technique capable of easily specifying a misalignment between a main body portion of a power transmission device and a mating member.

Hereinafter, embodiments for implementing a power transmission device of the present disclosure will be described. The same reference numerals will be assigned to the same or equivalent elements, and repeated description will be omitted. In each drawing, components are omitted, enlarged, or reduced as appropriate for convenience of description. The drawings should be viewed in accordance with a direction of the reference numerals.

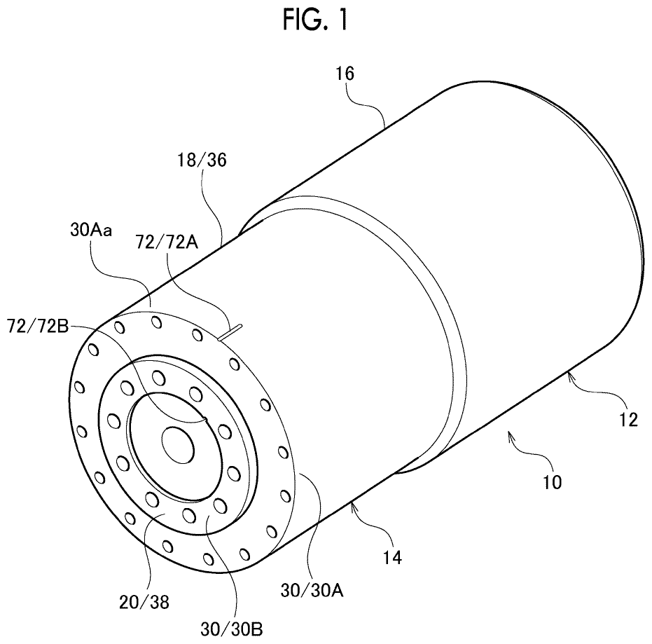

With reference to FIG. 1, an embodiment will be described. Hereinafter, a direction along a rotation center line of an output body 38 (to be described later) of a power transmission device 10 will be referred to as an axial direction, and a radial direction and a circumferential direction with reference to the rotation center line will be referred to as a radial direction and a circumferential direction. The power transmission device 10 is incorporated in a host machine. The power transmission device 10 can drive a driving target element (not shown) of the host machine by transmitting power generated by a prime mover and outputting the power. For example, the host machine includes (1) a robot such as an industrial robot and a service robot, (2) an industrial machine such as a machine tool and a construction machine, (3) a transport machine such as a conveyor, and (4) various machines such as a vehicle.

The host machine of the present embodiment is a robot, and more specifically, an articulated robot. The articulated robot includes a plurality of joint portions and a plurality of link members connected to each other in the joint portion. The power transmission device 10 of the present embodiment can connect the link members adjacent to each other in the joint portion and relatively rotate the link members by outputting rotation to one of the link members. The power transmission device 10 of the present embodiment is incorporated in each of the plurality of joint portions.

The power transmission device 10 of the present embodiment includes a prime mover 12 and a speed reducer 14 that decelerates and outputs the rotation input from the prime mover 12. For example, the prime mover 12 is a motor. A specific example of the motor is not particularly limited, and for example, various motors such as an AC motor and a DC motor may be adopted. The prime mover 12 includes a prime mover output shaft (not shown), a prime mover main body (not shown) that rotates the prime mover output shaft, and a prime mover casing 16 that accommodates the prime mover output shaft and the prime mover main body. For example, the prime mover main body is configured to include a stator and a rotor (not shown).

The speed reducer 14 includes a speed reducer input shaft (not shown) to which rotation is input from the prime mover output shaft, a reduction mechanism (not shown) that decelerates the rotation input to the speed reducer input shaft, a speed reducer casing 18 that accommodates the reduction mechanism, and an inner member 20 disposed inside the speed reducer casing 18. A specific example of the reduction mechanism is not particularly limited, and for example, an eccentric oscillating reduction mechanism, a bending meshing type reduction mechanism, a simple planetary reduction mechanism, or the like may be adopted. A specific example of the eccentric oscillating reduction mechanism is not particularly limited, and may be any of a center crank type and a sorting type. A specific example of the bending meshing type reduction mechanism is not particularly limited, and may be a cup type, a top hat type, a cylinder type, or the like. The reduction mechanism may be a traction drive or the like in addition to a gear mechanism. The speed reducer casing 18 is connected to the prime mover casing 16 by a bolt or the like.

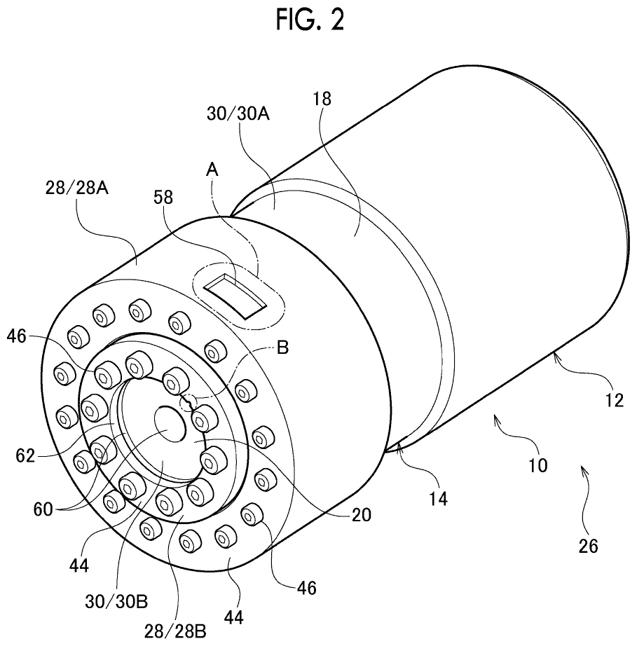

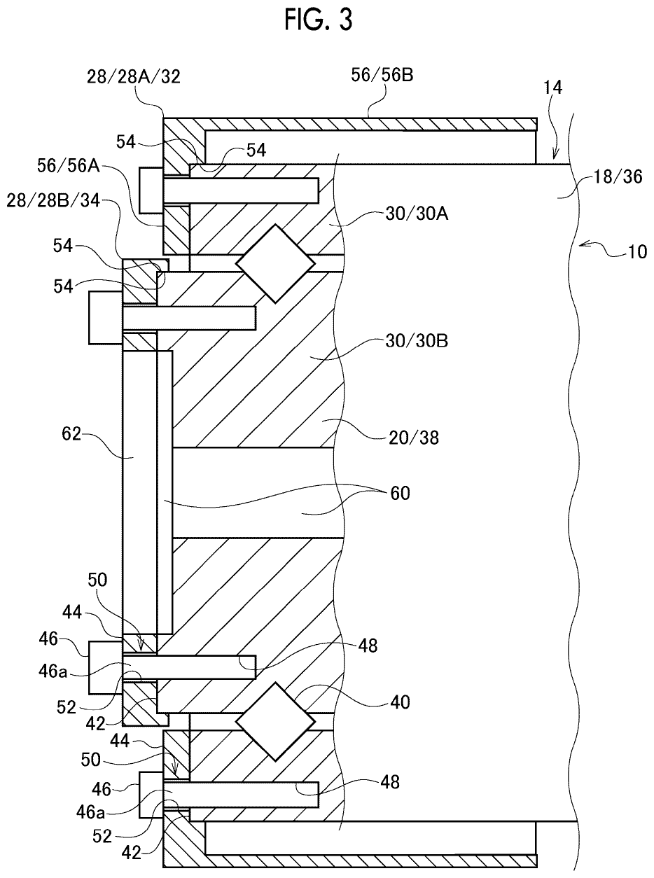

With reference to FIGS. 2 and 3, description will be continued. The power transmission device 10 configures a part of a power transmission unit 26. The power transmission unit 26 includes the power transmission device 10 and a mating member 28 that is a connection mate of the power transmission device 10 and that is disposed outside the power transmission device 10. The mating member 28 includes a first mating member 28A and a second mating member 28B. For example, each of the first and second mating members 28A and 28B is configured to include a link member connected to one joint portion of a robot. Specific examples of the first and second mating members 28A and 28B are not particularly limited.

The power transmission device 10 includes a main body portion 30 connected to the mating member 28. The main body portion 30 includes a first main body portion 30A connected to the first mating member 28A and a second main body portion 30B connected to the second mating member 28B. The second main body portion 30B is rotatable relative to the first main body portion 30A. In the present embodiment, an example in which the first main body portion 30A is the above-described speed reducer casing 18 and the second main body portion 30B is the above-described inner member 20 will be described.

In the present embodiment, the first mating member 28A is a support member 32 that supports the power transmission device 10, and the second mating member 28B is a driving target member 34 driven by the power transmission device 10. The driving target member 34 is a part of a driving target element of the host machine. In the present embodiment, the first main body portion 30A is a support target body 36 connected to the support member 32, and the second main body portion 30B is an output body 38 connected to the driving target member 34. The rotation decelerated more than the rotation of the speed reducer input shaft is transmitted to the output body 38 via the reduction mechanism. The output body 38 can output the rotation to the driving target member 34, thereby driving the driving target element including the driving target member 34. A main bearing 40 that supports the output body 38 is disposed between the support target body 36 and the output body 38.

The mating member 28 includes a connection target portion 44 connected to a connection portion 42 provided in the main body portion 30. In the present embodiment, each connection portion 42 of each of the main body portions 30A and 30B is provided in an axial end surface portion on one side (left side of a paper surface in FIG. 3) in the axial direction of each of the main body portions 30A and 30B. In the present embodiment, each connection target portion 44 of each of the mating members 28A and 28B is disposed on one side in the axial direction with respect to each connection portion 42 of each of the main body portions 30A and 30B. In the present embodiment, each connection target portion 44 of each of the first and second mating members 28A and 28B has an annular shape, and each connection portion 42 of each of the first and second main body portions 30A and 30B has an annular shape. The connection portion 42 of the first main body portion 30A is disposed outside the connection portion 42 of the second main body portion 30B in the radial direction. In addition, the connection target portion 44 of the first mating member 28A is disposed outside the connection target portion 44 of the second mating member 28B in the radial direction. The positions of the connection target portion 44 of the mating member 28 and the connection portion 42 of the main body portion 30 are not particularly limited.

The connection target portion 44 of the mating member 28 and the connection portion 42 of the main body portion 30 are fastened and connected to each other by a screw member 46. The screw member 46 is inserted into a main body hole 48 provided in the connection portion 42 of the main body portion 30. A female screw portion is provided in at least a part of the main body hole 48 of the present embodiment. The screw member 46 of the present embodiment is screwed into a female screw portion of the main body hole 48 to fasten the mating member 28 and the main body portion 30. In addition, the screw member 46 may be screwed into a nut provided separately from the connection portion 42 of the main body portion 30 to fasten the mating member 28 and the main body portion 30. In the present embodiment, a plurality of the main body holes 48 are provided in the connection portion 42 of the main body portion 30 at an interval in the circumferential direction, and the mating member 28 and the main body portion 30 are connected to each other by a plurality of the screw members 46 each inserted into each of the main body holes 48.

The mating member 28 includes a through-hole 52 into which a shaft portion 46a of the screw member 46 is inserted, and the shaft portion 46a is provided with a gap 50. The gap 50 is provided in an entire periphery range around the shaft portion 46a of the screw member 46 when a mating-side alignment mark portion 70 of the mating member 28 and a device-side alignment mark portion 72 of the main body portion 30 (to be described later) are located at reference positions.

The mating member 28 and the main body portion 30 include a pair of spigot joint surfaces 54 provided peripheral surfaces facing each other in the radial direction, the pair of spigot joint surfaces 54 being spigot-fitted. The mating member 28 and the main body portion 30 are connected to each other in a state where each of the spigot joint surfaces 54 is spigot-fitted.

The first mating member 28A includes a cover portion 56 that covers the first main body portion 30A, and a window portion 58 formed in the cover portion 56. The cover portion 56 of the present embodiment includes an axial cover portion 56A that covers an axial side surface of the first main body portion 30A from the axial direction, and a radial cover portion 56B that covers an outer peripheral surface of the first main body portion 30A from the radial direction. In the present embodiment, the connection target portion 44 described above is provided in the axial cover portion 56A. For example, the radial cover portion 56B of the present embodiment has a tubular shape such as a cylindrical shape, and the spigot joint surface 54 described above is provided in a part of the radial cover portion 56B. The window portion 58 of the present embodiment is formed in the radial cover portion 56B. A shape of the radial cover portion 56B is not limited to the cylindrical shape, and may have various tubular shapes such as an elliptical tubular shape and a rectangular tubular shape.

The second main body portion 30B may include a hollow portion 60 penetrating in the axial direction. The second mating member 28B may include a through-hole 62 that forms an internal space continuous with the hollow portion 60 of the second main body portion 30B. In addition, the second main body portion 30B may have a solid structure which does not include the hollow portion 60.

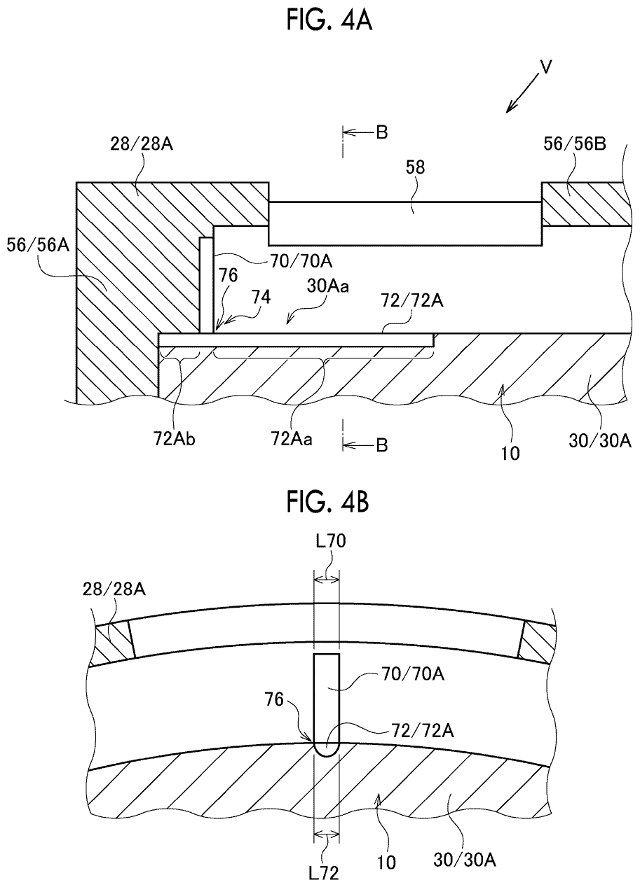

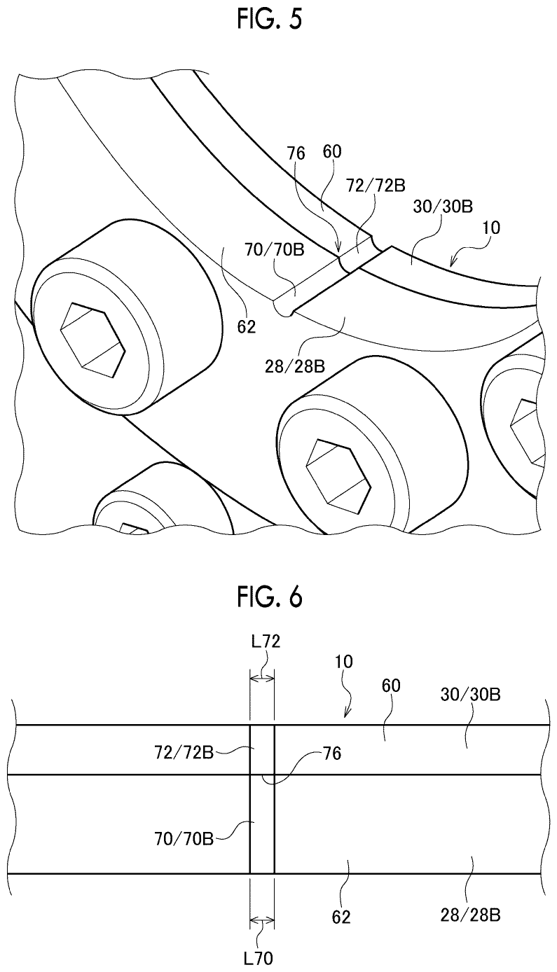

With reference to FIGS. 4A, 4B, 5, and 6, description will be continued. The mating-side alignment mark portion 70 is provided in the mating member 28. The mating-side alignment mark portion 70 of the present embodiment includes a first mating-side alignment mark portion 70A provided in the first mating member 28A, and a second mating-side alignment mark portion 70B provided in the second mating member 28B.

The power transmission device 10 includes a device-side alignment mark portion 72 provided in the main body portion 30. The device-side alignment mark portion 72 of the present embodiment includes a first device-side alignment mark portion 72A provided in the first main body portion 30A, and a second device-side alignment mark portion 72B provided in the second main body portion 30B.

The device-side alignment mark portion 72 is used to specify a misalignment between the mating member 28 and the main body portion 30 in an assumed misalignment direction assumed in advance in cooperation with the corresponding mating-side alignment mark portion 70. The mating-side alignment mark portion 70 and the device-side alignment mark portion 72 are used to specify the misalignment between the mating member 28 and the main body portion 30 in the assumed misalignment direction. Specifically, the first device-side alignment mark portion 72A corresponds to the first mating-side alignment mark portion 70A, and is used to specify the misalignment between the first mating member 28A and the first main body portion 30A in the assumed misalignment direction in cooperation with the first mating-side alignment mark portion 70A. The second device-side alignment mark portion 72B corresponds to the second mating-side alignment mark portion 70B, and is used to specify the misalignment between the second mating member 28B and the second main body portion 30B in the assumed misalignment direction in cooperation with the second mating-side alignment mark portion 70B. An example in which the assumed misalignment direction is the circumferential direction will be described in the present embodiment.

The mating-side alignment mark portion 70 and the device-side alignment mark portion 72, which correspond to each other, are provided at adjacent locations of the mating member 28 and the main body portion 30. In the present embodiment, the first mating-side alignment mark portion 70A and the first device-side alignment mark portion 72A are provided at adjacent locations of the first main body portion 30A and the first mating member 28A in the radial direction. In order to realize this configuration, as in the present embodiment, the first mating-side alignment mark portion 70A and the first device-side alignment mark portion 72A may be provided in a corner portion 74 formed by the first mating member 28A and the first main body portion 30A. In the present embodiment, the second mating-side alignment mark portion 70B and the second device-side alignment mark portion 72B are provided at adjacent locations of the second main body portion 30B and the second mating member 28B in the axial direction. In the present embodiment, the second device-side alignment mark portion 72B and the second mating-side alignment mark portion 70B are provided at locations where the second main body portion 30B and the second mating member 28B are flush with each other.

The mating-side alignment mark portion 70 and the device-side alignment mark portion 72, which correspond to each other, are provided on a surface of the mating member 28 and the main body portion 30. The “surface” here is a concept in which an outer surface and an inner surface of the described member are collectively included. The first mating-side alignment mark portion 70A of the present embodiment is provided on the inner surface of the first mating member 28A, specifically, on the inner surface of the axial cover portion 56A of the first mating member 28A. In addition, the first device-side alignment mark portion 72A of the present embodiment is provided on the outer surface of the first main body portion 30A, specifically, on the outer peripheral surface of the outer peripheral portion thereof. In addition, the second mating-side alignment mark portion 70B of the present embodiment is provided on the inner surface of the second mating member 28B, specifically, on the inner peripheral surface of the through-hole 62 thereof. In addition, the second device-side alignment mark portion 72B of the present embodiment is provided on the inner surface of the second main body portion 30B, specifically, on the inner peripheral surface of the hollow portion 60 thereof.

The mating-side alignment mark portion 70 may be configured to include a recessed portion or a protruding portion provided in the mating member 28. The recessed portion or the protruding portion here refers to a portion formed integrally with another portion of the mating member 28 on the surface of the mating member 28. The device-side alignment mark portion 72 may be configured to include a recessed portion or a protruding portion provided on the surface of the main body portion 30. The recessed portion or the protruding portion here refers to a portion formed integrally with another portion of the main body portion 30 on the surface of the main body portion 30. In the present embodiment, each of the alignment mark portions 70 and 72 is formed by a linear recessed portion, that is, a groove portion. In addition, each of the alignment mark portions 70 and 72 may be formed by a linear protruding portion, that is, a ridge portion. The recessed portion forming each of the alignment mark portions 70 and 72 may be provided by cutting a part of the surface of the mating member 28 or the main body portion 30.

In the present embodiment, each of the mating-side alignment mark portion 70 and the device-side alignment mark portion 72, which correspond to each other, is continuous with a boundary portion 76 between the mating member 28 and the main body portion 30. The first device-side alignment mark portion 72A includes a first portion 72Aa continuous with the boundary portion 76 between the first mating member 28A and the first main body portion 30A and recognizable from the outside, and a second portion 72Ab continuous with the boundary portion 76 and covered and hidden by the first mating member 28A. The second portion 72Ab of the first device-side alignment mark portion 72A is covered and hidden by the first mating member 28A. In this manner, the second portion 72Ab of the first device-side alignment mark portion 72A is not recognizable from the outside.

Each of the mating-side alignment mark portion 70 and the device-side alignment mark portion 72 of the present embodiment has a linear shape extending from the boundary portion 76 between the mating member 28 and the main body portion 30. Specifically, the first mating-side alignment mark portion 70A has a linear shape extending in the radial direction from the boundary portion 76 between the first mating member 28A and the first main body portion 30A, and the first device-side alignment mark portion 72A has a linear shape extending in the axial direction from the boundary portion 76. The second mating-side alignment mark portion 70B has a linear shape extending in the axial direction from the boundary portion 76 between the second mating member 28B and the second main body portion 30B, and the second device-side alignment mark portion 72B has a linear shape extending in the axial direction from the boundary portion 76. In the present embodiment, each of the alignment mark portions 70 and 72 has a linear shape.

The mating-side alignment mark portion 70 and the device-side alignment mark portion 72, which correspond to each other, have a linear shape having equal line widths L70 and L72. The line width L70 of the mating-side alignment mark portion 70 and the line width L72 of the device-side alignment mark portion 72 are equal to each other. The line widths L70 and L72 here refer to dimensions of the alignment mark portions 70 and 72 in a width direction perpendicular to a length direction of a line formed by the alignment mark portions 70 and 72. The width direction is a direction in which the alignment mark portions 70 and 72 and the other location of the surface of the mating member 28 or the main body portion 30 are adjacent to each other. The “equal” here is a concept including the same or substantially the same.

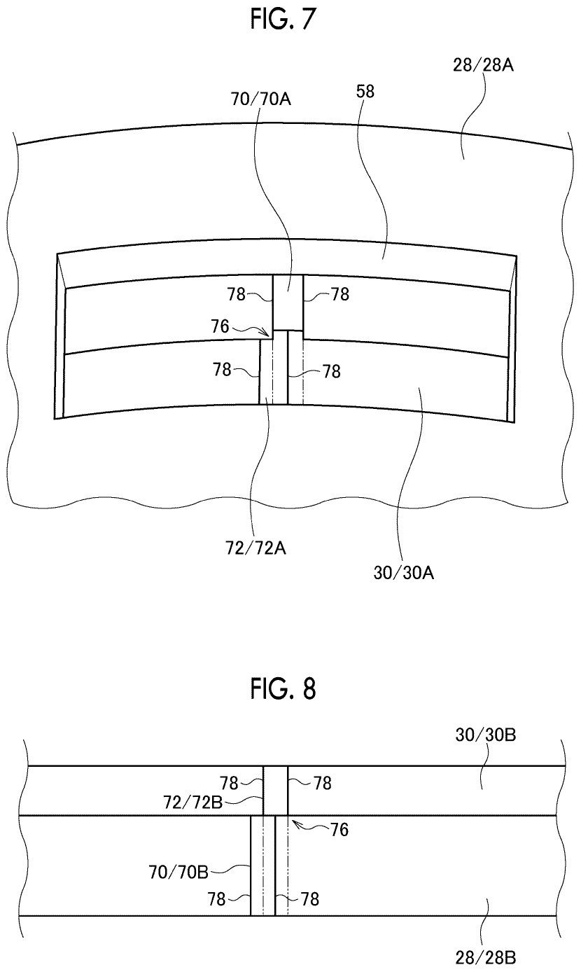

With reference to FIGS. 7 and 8, description will be continued. FIG. 7 is a view showing the first mating-side alignment mark portion 70A and the first device-side alignment mark portion 72A through the window portion 58 of the first mating member 28A when viewed in a direction of an arrow V in FIG. 4A. The mating-side alignment mark portion 70 and the device-side alignment mark portion 72 which correspond to each other are aligned to be disposed at a predetermined reference position. In FIGS. 7 and 8, a state where each of the alignment mark portions 70 and 72 is disposed at the reference position is shown by a two-dot chain line, and a state where each of the alignment mark portions 70 and 72 is misaligned from the reference position is shown by a solid line.

Each of the alignment mark portions 70 and 72 of the present embodiment has a linear shape having equal line widths. The reference position of the present embodiment is a position where positions of both side portions 78 of the alignment mark portions 70 and 72 in the assumed misalignment direction (here, the circumferential direction) in the boundary portion 76 between the mating member 28 and the main body portion 30 are aligned. In addition, each of the alignment mark portions 70 and 72 corresponding to each other may be formed in a shape obtained by dividing a predetermined shape (for example, a circular shape, a polygonal shape, or the like) into two pieces, and a position where a combination of the alignment mark portions 70 and 72 has a predetermined shape may be set as the reference position. In addition, a position where positions in the assumed misalignment direction of predetermined portions (for example, arrow tip portions of arrow marks) indicated by the alignment mark portions 70 and 72 coincide with each other may be set as the reference position. In this way, a shape of each of the alignment mark portions 70 and 72 or a condition to be satisfied when each of the alignment mark portions 70 and 72 is located at the reference position is not particularly limited, and various shapes or conditions may be adopted.

Since it is recognized that a relative position between the mating-side alignment mark portion 70 and the device-side alignment mark portion 72 is the reference position, it is possible to specify that there is no misalignment in the assumed misalignment direction between the main body portion 30 and the mating member 28. In addition, since it is recognized that the relative positions between the mating-side alignment mark portion 70 and the device-side alignment mark portion 72 are misaligned from the reference positions in the assumed misalignment direction, or a degree of the misalignment from the reference positions is recognized, it is possible to specify that the misalignment between the main body portion 30 and the mating member 28 occurs in the assumed misalignment direction, or it is possible to specify the degree of the misalignment. That is, since the relative positions between the mating-side alignment mark portion 70 and the device-side alignment mark portion 72 which correspond to each other are recognized, it is possible to specify the presence or absence and the degree of the misalignment between the main body portion 30 and the mating member 28. Specific means for recognizing the relative positions between the mating-side alignment mark portion 70 and the device-side alignment mark portion 72 which correspond to each other is not particularly limited. For example, the relative positions may be recognized by a worker's visual inspection, or may be recognized by performing image processing on an image captured by an imaging device such as a camera.

An example of an assembly method for the power transmission unit 26 described above will be described. A case where the mating member 28 is connected to the main body portion 30 will be considered. In this case, the main body portion 30 and the mating member 28 are aligned with each other in the assumed misalignment direction such that the mating-side alignment mark portion 70 and the device-side alignment mark portion 72 which correspond to each other are disposed at the reference positions. Thereafter, the mating member 28 is connected to the main body portion 30 to fix both the relative positions.

In the present embodiment, the screw member 46 is screwed into a female screw portion of the main body hole 48 of the main body portion 30 in a state where the shaft portion 46a of the screw member 46 passes through the through-hole 52 of the mating member 28. In this case, tightening of each of the plurality of screw members 46 is loosened, and the relative position of the mating member 28 with respect to the main body portion 30 is brought into a slightly adjustable state. In this state, the main body portion 30 and the mating member 28 are aligned in the assumed misalignment direction such that the mating-side alignment mark portion 70 and the device-side alignment mark portion 72 are disposed at the reference positions. Thereafter, the mating member 28 is connected to the main body portion 30 by tightening the screw member 46, and both the relative positions are fixed.

Advantageous effects of the power transmission device 10 and the power transmission unit 26 described above will be described.

When a strong impact load or the like is applied to the main body portion 30 of the power transmission device or to the mating member 28, the mating-side alignment mark portion 70 and the device-side alignment mark portion 72 may be misaligned in the assumed misalignment direction from the predetermined reference position. As a result, there is a possibility that the main body portion 30 and the mating member 28 are misaligned. Even when both of these are misaligned, the relative positions between the mating-side alignment mark portion 70 and the device-side alignment mark portion 72 are recognized. In this manner, the presence or absence or the degree of the misalignment between the main body portion 30 of the power transmission device 10 and the mating member 28 can be easily specified. When it is necessary to precisely control a position of a driving target element of a host machine, and when the mating member 28 and the main body portion 30 are significantly misaligned, it is desirable to quickly specify the misalignment and to carry out restoration work. According to the present embodiment, there is an advantage in that this misalignment can be specified at an early stage and the restoration work for eliminating the misalignment can be carried out promptly. In particular, when the power transmission unit 26 is incorporated in a plurality of locations of the host machine as in the present embodiment, there is an advantage in that it is possible to quickly specify which power transmission unit 26 is misaligned.

When each of the alignment mark portions 70 and 72 are formed of ink, paint, or the like, there is a problem in that the ink or the like is likely to wear off over time. In this regard, each of the alignment mark portions 70 and 72 of the present embodiment is configured to include a recessed portion. Therefore, compared to a case where each of the alignment mark portions 70 and 72 is formed of the ink, the paint, or the like, the alignment mark portions 70 and 72 are less likely to wear off over time. Therefore, each of the alignment mark portions 70 and 72 is recognizable for a long period of time. The same advantageous effect can be obtained even when at least one of the alignment mark portions 70 and 72 is configured to include a protruding portion instead of the recessed portion. However, in order to reduce the burden required for a process for providing the alignment mark portions 70 and 72, it is preferable that at least one of the mating-side alignment mark portion 70 and the device-side alignment mark portion 72 is configured to include the recessed portion.

In order for the power transmission device 10 to output the rotation, a torque acts on each main body portion 30. For example, when a rotation torque is transmitted to the second main body portion 30B serving as the output body 38 by the power transmission device 10, a rotation torque acts on the second main body portion 30B. In addition, when the rotation torque is transmitted to the first main body portion 30A serving as the support target body 36 by the power transmission device 10, a reaction torque acts on the first main body portion 30A due to influence of the reaction. Due to this influence, when a large torque acts on each main body portion 30 due to an impact or the like, there is a possibility that the mating member 28 and the main body portion 30 are misaligned from the reference positions in the circumferential direction. In addition, there is a possibility that the mating member 28 and the main body portion 30 are misaligned in the circumferential direction due to the influence of the loosening of the screw member 46 which is caused by the influence of vibration or the like. The device-side alignment mark portion 72 of the present embodiment is used to specify the misalignment between the mating member 28 and the main body portion 30 in the circumferential direction in cooperation with the corresponding mating-side alignment mark portion 70. Therefore, even when the mating member 28 and the main body portion 30 are misaligned in the circumferential direction, there is an advantage in that the misalignment can be specified by using each of the alignment mark portions 70 and 72.

The device-side alignment mark portion 72 of the present embodiment includes the first device-side alignment mark portion 72A for specifying the misalignment between the first mating member 28A and the first main body portion 30A, and the second device-side alignment mark portion 72B for specifying the misalignment between the second mating member 28B and the second main body portion 30B. Therefore, since the relative positions between the first mating-side alignment mark portion 70A and the first device-side alignment mark portion 72A are recognized, the misalignment in the assumed misalignment direction between the first mating member 28A and the first main body portion 30A can be specified. In addition, since the relative positions between the second mating-side alignment mark portion 70B and the second device-side alignment mark portion 72B are recognized, the misalignment in the assumed misalignment direction between the second mating member 28B and the second main body portion 30B can be specified. As a result, since these configurations are used, when a rotational position of the driving target element including the driving target member 34 is misaligned from a proper position, it is possible to quickly specify that any one of a set of the first mating member 28A and the first main body portion 30A and a set of the second mating member 28B and the second main body portion 30B is misaligned in the assumed misalignment direction. The proper position here is a relative position of the driving target element with respect to the output body 38 of the power transmission device 10 in a rotation direction, and is a position where the driving target element has to be located when each of the alignment mark portions 70 and 72 is located at the reference position.

The device-side alignment mark portion 72 and the mating-side alignment mark portion 70 extend from the boundary portion 76 between the mating member 28 and the main body portion 30, and form a linear shape having equal line widths. In this manner, a position where the positions of both side portions 78 of each of the alignment mark portions 70 and 72 are aligned with each other at the boundary portion 76 between the mating member 28 and the main body portion 30 is the reference position. When both of these are misaligned from the reference position, the positions of both side portions 78 of each of the alignment mark portions 70 and 72 at the boundary portion 76 between the mating member 28 and the main body portion 30 are displaced. Therefore, the misalignment is easily recognized.

The mating member 28 includes the through-hole 52 into which the shaft portion 46a of the screw member 46 is inserted with the gap 50. In this manner, the mating member 28 and the main body portion 30 may be misaligned as much as the gap 50. Even when the misalignment caused by this gap 50 occurs between the mating member 28 and the main body portion 30, the misalignment between both of these can be specified by using the alignment mark portions 70 and 72 provided in each of the mating member 28 and the main body portion 30.

Next, other characteristics of the power transmission device 10 and the power transmission unit 26 will be described. With reference to FIGS. 4A, 4B, and 7, description will be continued. The first device-side alignment mark portion 72A is provided in the outer peripheral portion of the first main body portion 30A. The cover portion 56 (radial cover portion 56B) of the first mating member 28A covers at least a part of the outer peripheral portion of the first main body portion 30A. The cover portion 56 covers at least a part of the first device-side alignment mark portion 72A when the window portion 58 is not provided in the cover portion 56. In the present embodiment, the entire first device-side alignment mark portion 72A is covered. The first device-side alignment mark portion 72A of the present embodiment is provided in an axial end portion 30Aa of the outer peripheral portion of the first main body portion 30A (refer to FIG. 1).

The first device-side alignment mark portion 72A and the first mating-side alignment mark portion 70A are provided at positions where at least a part is recognizable from the outside through the window portion 58. The “position recognizable from the outside” here may be a position recognizable by a worker's visual inspection from the outside, or may be a position recognizable in an image captured by an imaging device from the outside. The “outside” here means the outside of the power transmission unit 26 in which the power transmission device 10 and the mating member 28 are combined. In order to satisfy a condition of “recognizable from the outside”, when another member covering the power transmission unit 26 is present, and when it is assumed that there is no other member, each of the alignment mark portions 70 and 72 may be recognized when the power transmission unit 26 is viewed from the outside. The window portion 58 of the present embodiment causes an internal space between the cover portion 56 of the first mating member 28A and the first main body portion 30A to communicate with an external space outside the cover portion 56. In addition, the window portion 58 may be closed with a transparent lid material. In this case, the device-side alignment mark portion 72 is recognizable from the outside through the transparent lid material and the window portion 58.

When the first device-side alignment mark portion 72A is covered with the cover portion 56 of the first mating member 28A or when the first mating-side alignment mark portion 70A is provided on the inner surface of the first mating member 28A, each of the alignment mark portions 70A and 72A is not recognizable from the outside of the power transmission unit 26. Even in this case, each of the alignment mark portions 70A and 72A is recognizable from the outside through the window portion 58 of the first mating member 28A.

A case where the first device-side alignment mark portion 72A is provided in the outer peripheral portion of the first main body portion 30A and the cover portion 56 of the first mating member 28A covers the outer peripheral portion of the first main body portion 30A will be considered. In this case, when the first mating member 28A does not have the window portion 58, in order that the first device-side alignment mark portion 72A of the first main body portion 30A is recognizable from the outside, it is necessary to expose the first device-side alignment mark portion 72A from the cover portion 56 of the first mating member 28A. Here, an axial dimension of the cover portion 56 of the first mating member 28A may vary in various ways, depending on an installation location of the power transmission unit 26. In this case, in order to expose the first device-side alignment mark portion 72A regardless of the axial dimension of the cover portion 56 of the first mating member 28A, it is necessary to excessively increase the axial dimension of the first device-side alignment mark portion 72A. In this regard, according to the present embodiment, even when the axial dimension of the first device-side alignment mark portion 72A is not increased, there is an advantage in that the first device-side alignment mark portion 72A is recognizable from the outside through the window portion 58.

Next, modification examples of each component described so far will be described.

An example in which the power transmission device 10 includes the prime mover 12 and the speed reducer 14 has been described. However, the power transmission device 10 is not limited thereto, and may include only the speed reducer 14. In this case, the prime mover 12 is not limited to the motor, and may be an engine or the like. The power transmission unit 26 may include one mating member 28 provided with at least the mating-side alignment mark portion 70 out of the first mating member 28A and the second mating member 28B.

Hitherto, an example has been described in which each of a set of the first mating member 28A and the first main body portion 30A and a set of the second mating member 28B and the second main body portion 30B is provided with the corresponding mating-side alignment mark portion 70 and the corresponding device-side alignment mark portion 72. Without being limited thereto, only one of the former set and the latter set may be provided with the corresponding mating-side alignment mark portion 70 and the corresponding device-side alignment mark portion 72.

The first mating member 28A may be the driving target member 34, and the second mating member 28B may be the support member 32. In this case, the first main body portion 30A is the output body 38 that drives the driving target member 34, and the second main body portion 30B is the support target body 36 supported by the support member 32.

Each of the alignment mark portions 70 and 72 does not need to include the recessed portion or the protruding portion. For example, each of the alignment mark portions 70 and 72 may be formed of the ink, the paint, or the like applied to the surface of the mating member 28 or the main body portion 30. In addition, at least one of the mating-side alignment mark portion 70 and the device-side alignment mark portion 72 may be configured to include the recessed portion or the protruding portion, and the other may be formed of the ink, the paint, or the like. One of the alignment mark portions 70 and 72 may be configured to include the recessed portion or the protruding portion, and the recessed portion or the protruding portion may be coated with the ink or the paint.

A direction of the misalignment (assumed misalignment direction) between the mating member 28 and the main body portion 30 which are specified by the device-side alignment mark portion 72 and the mating-side alignment mark portion 70, which correspond to each other, is not limited to the circumferential direction. For example, the assumed misalignment direction may be the axial direction or the radial direction.

The mating member 28 and the main body portion 30 may be connected to each other by using a member other than the screw member 46. For example, these may be connected to each other by friction bonding or the like.

When the mating-side alignment mark portion 70 and the device-side alignment mark portion 72 have the linear shape, the line widths of the alignment mark portions 70 and 72 may be different from each other. In this case, for example, in the boundary portion 76 between the mating member 28 and the main body portion 30, a position where the positions of the entire alignment mark portions having a small line width are aligned in the assumed misalignment direction with respect to a part of the alignment mark portion having a large line width may be set as the reference position.

In the embodiment, an example has been described in which the window portion 58 of the first mating member 28A is provided in the radial cover portion 56B. Without being limited thereto, for example, the window portion 58 of the first mating member 28A may be provided in the axial cover portion 56A or the like.

Any combination of the above-described components is also valid. For example, any description items described in the embodiments may be combined with each other, or any description items described in each of the embodiments and the modification examples may be combined with each other. For example, characteristics (for example, characteristics relating to the corner portion 74) relating to the first mating-side alignment mark portion 70A and the first device-side alignment mark portion 72A may be applied to the second mating-side alignment mark portion 70B and the second device-side alignment mark portion 72B. In addition, characteristics relating to the first mating member 28A (for example, characteristics relating to the cover portion 56 and the window portion 58) may be applied to the second mating member 28B.

The contents of each component described in the above-described embodiments and the like are merely examples. The technical idea abstracted from these contents should not be interpreted in a limited manner in the contents of the present specification. The contents of each component described in the embodiments or the like can be changed, added, deleted, or the like, and many changes in design can be made. The description is emphasized by adding the notation of “the present embodiment” and “the embodiment” to the contents in which such a change in design can be made. However, changes in design are allowed even when there is no notation in the contents. Structures and numerical values as mentioned in the embodiments and modification examples naturally include those that can be regarded as the same when manufacturing errors and the like are taken into consideration. The components configured to include a singular member in the description in the present specification may be configured to include a plurality of members. Similarly, the components configured to include a plurality of members may be configured to include a singular member.

It should be understood that the invention is not limited to the above-described embodiment, but may be modified into various forms on the basis of the spirit of the invention. Additionally, the modifications are included in the scope of the invention.

What is claimed is:

1. A power transmission device comprising:
a main body portion connected to a mating member disposed outside the power transmission device; and
a device-side alignment mark portion provided in the main body portion to specify a misalignment between the main body portion and the mating member in cooperation with a mating-side alignment mark portion provided in the mating member.

2. The power transmission device according to claim 1,
wherein the main body portion includes a connection portion connected to a connection target portion of the mating member.

3. The power transmission device according to claim 1,
wherein the mating member and the main body portion include a pair of spigot joint surfaces provided on peripheral surfaces facing each other in a radial direction, the pair of spigot joint surfaces being spigot-fitted.

4. The power transmission device according to claim 1,
wherein the device-side alignment mark portion is configured to include a recessed portion or a protruding portion provided in the main body portion.

5. The power transmission device according to claim 4,
wherein the recessed portion or the protruding portion is a portion formed integrally with another portion of the main body portion on a surface of the main body portion.

6. The power transmission device according to claim 1,
wherein the device-side alignment mark portion specifies the misalignment between the main body portion and the mating member in a circumferential direction in cooperation with the mating-side alignment mark portion.

7. The power transmission device according to claim 1,
wherein the main body portion includes a first main body portion connected to a first mating member, and a second main body portion connected to a second mating member and rotatable relative to the first main body portion, and
the device-side alignment mark portion includes a first device-side alignment mark portion for specifying a misalignment between the first mating member and the first main body portion in cooperation with a first mating-side alignment mark portion provided in the first mating member, and a second device-side alignment mark portion for specifying a misalignment between the second mating member and the second main body portion in cooperation with a second mating-side alignment mark portion provided in the second mating member.

8. The power transmission device according to claim 7,
wherein the first mating-side alignment mark portion and the first device-side alignment mark portion are provided at adjacent locations of the first main body portion and the first mating member in a radial direction.

9. The power transmission device according to claim 8,
wherein the second mating-side alignment mark portion and the second device-side alignment mark portion are provided at adjacent locations of the second main body portion and the second mating member in an axial direction.

10. A power transmission unit comprising:
the power transmission device according to claim 1; and
a mating member connected to the main body portion and provided with the mating-side alignment mark portion.

11. The power transmission unit according to claim 10,
wherein the mating member is fastened to the main body portion by a screw member, and
the mating member includes a through-hole into which a shaft portion of the screw member is inserted with a gap.

12. The power transmission unit according to claim 10,
wherein each of the mating-side alignment mark portion and the device-side alignment mark portion has a linear shape extending from a boundary portion between the main body portion and the mating member and having equal line widths.

13. The power transmission unit according to claim 10,
wherein the mating member includes a cover portion that covers the main body portion, and a window portion formed in the cover portion, and
the device-side alignment mark portion and the mating-side alignment mark portion are provided at positions recognizable from an outside through the window portion.

14. The power transmission unit according to claim 13,
wherein the device-side alignment mark portion is provided in an outer peripheral portion of the main body portion, and
the cover portion covers the outer peripheral portion of the main body portion.
